(19) United States
(12) Patent Application Publication
(10) Pub. No.: US 2017/0046747 A1
(43) Pub. Date: Feb. 16, 2017

(54) Optimal Dynamic Bidding

(71) Applicant: Conversant, LLC, Chicago, IL (US)

(72) Inventor: Shuanglong Wang, Champaign, IL (US)

(21) Appl. No.: 15/237,612

(22) Filed: Aug. 15, 2016

Related U.S. Application Data
(60) Provisional application No. 62/205,495, filed on Aug. 14, 2015.

(51) Int. Cl. G06Q 30/02

(52) U.S. Cl. CPC G06Q 30/0275; G06Q 30/0247

(57) ABSTRACT

Dynamic Markovian techniques are used to determine an appropriate bidding price for an online advertisement without the use of heuristics. Upon determining an optimal bid price, a bid may be made for an online advertisement using the optimal bid price.

### TECHNICAL FIELD

The present invention relates to the field of online advertising, and in particular to techniques for identifying a bidding price for an online advertisement.

### BACKGROUND ART

Advertising technology companies connect brand advertisers with their audiences through high quality, targeted, and brand safe campaigns at scale. Advertisements are typically handled using a bidding process, but determining an appropriate bidding price has been difficult and depended upon heuristics. A better bidding price determination technique would be desirable.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a graph illustrating expected profit versus attribution state along attribution state.

FIG. 2 is a graph illustrating bid price versus attribution state along attribution state.

FIG. 3 is a graph illustrating attribute conversion probability versus attribution state along attribution state.

FIG. 4 is a graph illustrating expected cost versus attribution state along attribution state.

FIG. 5 is a graph illustrating expected profit versus time along time since registration.

FIG. 6 is a graph illustrating bid price versus time along time since registration.

FIG. 7 is a graph illustrating attribution conversion probability versus time along the time since registration.

FIG. 8 is a graph illustrating expected cost versus time along time since registration.

FIG. 9 is a graph illustrating profit versus number of impression opportunity along number of bidding opportunities along number of bidding opportunities.

FIG. 10 is a graph illustrating first bid price versus number of impressions opportunity along number of bidding opportunities.

FIG. 11 is a graph illustrating attributed conversion probability versus number of impressions opportunity along number of bidding opportunities.

FIG. 12 is a graph illustrating expected cost versus number of impressions opportunity along number of bidding opportunities.

FIG. 13 is a flowchart illustrating a technique for calculating optimal bid prices, expectations of profit, and expected costs for bidding on an advertisement according to one embodiment.

FIG. 14 is a block diagram illustrating a computer system that can be programmed to calculate the optimal bid price according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

As described below, dynamic Markovian techniques are used to determine an appropriate bidding price for an online advertisement.

The scheme is based on Markov decision process, where it is assumed that all the processes involved are Markovian. The bidding strategy serves for a single costumer with a single conversion, it could start at any time but end at a conversion. So after a conversion happens, the whole process should be relaunched, but all the parameters can be updated by the history of conversions. The strategy lets us adjust bidding to try to space advertisements correctly, to provide a desired time between one advertisement for a customer and the next advertisement for that customer. In general, the bid price is dropped if an advertisement for the customer has just shown. Unlike heuristic-based techniques, the disclosed technique generates an expected value and computes a precise price to use as the bid price. Implementation on a computer is computationally intensive.

In general, the strategy is to divide an ad period into intervals. Determine the proper price for the ad in the last interval, then use dynamic programming techniques to work backwards.

Assuming the remaining value for conversion after the final period is negligible, we are only making money out of the bidding operations. The more bidding opportunity, usually, the higher probability of an attributed conversion, thus the higher price we can bid and the more premium we are able to earn.

The optimal bid price thus becomes how much an impression now will boost the current and following periods' revenue.

The optimal revenue thus becomes the expected bidding premium plus the expected attributed conversion revenue given on impression delivered in the current period and following periods' revenue without an impression or conversion now.

In the disclosure of this dynamic bidding strategy, the following function are defined:

w(b, t) is the win rate function that gives the wining rate for an arbitrary bidding price at a particular time.

cost(b, t) is the cost function that gives the conditional expectation of bidding cost given winning.

p(b, t) is the premium function that gives the expectation of bidding profit.

The cost function is a conditional expectation while the premium function is an expectation. The three functions follow the equation below:

p(b, t)=w(b, t)*(b−cost(b, t))

We also use a conditional conversion probability f with state variable \vec{C}. The state variable \vec{C} has its own Markovian evolving process

\vec{C}(t)=h(t₀, t, \vec{c})

where t₀ denotes the starting time and e denotes the starting state.

The formula for \vec{C} satisfies h(t₀, t₀, \vec{c})=\vec{c}. To make the Markov process time-invariant, the functional form can be written as h(t−t₀, \vec{c}), which satisfies h(0, \vec{c})=\vec{c}. Furthermore, h can be made to be a random variable.

Next, the variable T_{C} denotes the random variable of conversion time. f may then be expressed as:

f(t₀, t, \vec{c})=P(T_{C}=t|T_{C}>t₀, \vec{c}) (conditional probability density)

\vec{C} in one embodiment contains two parts, as indicated below:

$$\vec{{c}_{0}} = \vec{C} ( {t}_{0} ) = [ \begin{matrix}{α}_{0} \\ P ( {T}_{c} < {t}_{0} )\end{matrix} ] = [ \begin{matrix}{α}_{0} \\ {p}_{0}\end{matrix} ]$$

The first part is a parameter for a rate function and the second part is used to record probability for the conditional event. Then let:

$$h ( {t}_{0} , t , \vec{c} ) = [ \begin{matrix}{h}_{1} ( {t}_{0} , t , \vec{c} ) \\ {h}_{2} ( {t}_{0} , t , \vec{c} )\end{matrix} ]$$

Therefore, h₁may solely depend on α, and the second part has to follow the law of total probability.

$${h}_{1} ( {t}_{0} , t , \vec{c} ) = {h}_{1} ( {t}_{0} , t , α ) , \\ {h}_{2} ( {t}_{0} , t , \vec{c} ) = P ( {T}_{C} < t ) = {p}_{0} + ( 1 - {p}_{0} ) * {\int }_{{t}_{0}}^{t} f ( {t}_{0} , t , \vec{c} ) * d t$$

Finally, the conditional probability density can be defined by a rate function ι divided by the probability of the conditional event.

$$f ( {t}_{0} , t , \vec{c} ) = \frac{l ( α ( t ) )}{1 - {p}_{0}} = \frac{l ( {h}_{1} ( {t}_{0} , t , {α}_{0} ) )}{1 - {c}_{0} [ 2 ]} = \frac{l ( C ( t ) [ 1 ] )}{1 - {c}_{0} [ 2 ]}$$

To make the scheme well defined, in one embodiment,

$${\int }_{{t}_{0}}^{∞} f ( {t}_{0} , t , \vec{c} ) * d t \leq 1$$

An attribution model function k may be defined with state variable \vec{A}, as indicated below:

Again, we need an evolving process for \vec{A}:

\vec{A}(t)=k(t₀, t, \vec{α})

where t₀ denotes the starting time and \vec{α} denotes the starting state. k can be made to be a random variable as well.

Next, since there is no history-related conditional probability involved, we can simply let g(\vec{α}) denote the attribution rate at time t₀ given that \vec{A}(t₀)=α.

Although these functions are continuous in time, resulting in a lot of integrations in the following discussion, in some embodiments, if the function is flat within given period, we can substitute constants for the functions.

Impact of impression

An impression is assumed to be able to change the state variable of both conversion and attribution. In one embodiment, the resulting state variables are \vec{c₀}(t, \vec{c}) and \vec{α₀}(t, \vec{α}). In other embodiments, the state variables can be random variables. In one embodiment, c[2] should not be changed while c[1] can be changed based on users' specification.

Dynamic Programming:

In one embodiment, first assume the horizon to be finite, i.e., that there are a finite number of time points N for sending out a bidding request. Our control is achieved by adjusting the bid price. Let's then give one more parameter “M” for a unit CPA payment.

Final period

In the final period T_{N}, to make the profit calculation more intuitive, in one embodiment we may pretend that we know how much we have spent (X) in the prior time periods. The calculation described below shows that the amount spent would not have any influence on the optimal bid price in the final period. Let ACₜ denote the event that an attributed conversion happened after time t, given no conversion happened before time t. Then the expectation of profit given bid price b may be expressed as:

$${E}_{{T}_{N}} [ Profit \vert \vec{c} , \vec{a} , X ] ( b ) = w ( b , {T}_{N} ) [ M * P ( A {C}_{{T}_{N}} \vert \vec{{c}_{0}} ( {T}_{N} , c ) , \vec{{a}_{0}} ( {T}_{N} , \vec{a} ) ) - X - cost ( b , {T}_{N} ) ] + ( 1 - w ( b , {T}_{N} ) ) [ M * P ( A {C}_{{T}_{N}} \vert \vec{c} , \vec{a} ) - X ] = w ( b , {T}_{N} ) [ M * ( P ( A {C}_{{T}_{N}} \vert \vec{{c}_{0}} ( {T}_{N} , c ) , \vec{{a}_{0}} ( {T}_{N} , \vec{a} ) ) - P ( A {C}_{{T}_{N}} \vert \vec{c} , \vec{a} ) ) - cost ( b , {T}_{N} ) ] + M * P ( A {C}_{{T}_{N}} \vert \vec{c} , \vec{a} ) - X$$

By the well-known conclusion of second-price auctions, the optimal price b* equals:

b*=M*(P(AC_{T}_{_{N}}|\vec{c₀}(T_{N},\vec{c}), \vec{α₀}(T_{N} , \vec{α}))−P(AC_{T}_{_{N}}|\vec{c}, \vec{α}))

where

$$P ( A {C}_{{T}_{N}} \vert \vec{c} , \vec{a} ) = {\int }_{{T}_{N}}^{∞} f ( {T}_{N} , t , \vec{c} ) * g ( k ( {T}_{N} , t , \vec{a} ) ) * d t$$

In embodiments where \vec{c₀}(t) and \vec{a₀}(t) are random variables, the term

P_{T}_{_{N}}(AC_{T}_{_{N}}|\vec{c₀}(T_{N}, \vec{c}), \vec{a₀}(T_{N} , \vec{a}))

may be substituted by E\vec{_{c}_{₀}}_{(T}_{_{N}}, \vec{c}), \vec{α0}_{(T}_{_{N}}_{, \vec{α})}[P(AC_{T}_{_{N}}|\vec{c₀}(T_{N}, \vec{c}), \vec{α₀}(T_{N}, \vec{α}))]. Alternately, the term may be represented intuitively by:

P(AC_{T}_{_{N}}|impression delivered at T_{N}, \vec{c}, \vec{α})

In sum:

b*=M*(P(AC_{T}_{_{N}}|impression delivered at T_{N}, \vec{c}, \vec{α})−P(AC_{T}_{_{N}}|\vec{c}, \vec{α}))

E_{T}_{_{N}}[Profit|\vec{c}, \vec{α}, X]*=p(b*, T_{N})+M*P(AC_{T}_{_{N}}|\vec{c}, \vec{α})−X

Let's then define the value function V_{T}(\vec{c}, \vec{α}, X) for the final period as:

V_{T}_{_{N}}(\vec{c}, \vec{α}, X)=p(b*, T_{N})+M*P(AC_{T}_{_{N}}|\vec{c}, \vec{α})−X

In one embodiment, the revenue function is also defined as:

R_{T}_{_{N}}(\vec{c}, \vec{α})=p(b*, T_{N})+M*P(AC_{T}_{_{N}}|\vec{c}, \vec{α})

Period T_{N-1}

Again, let's assume that we know the cost spent in the prior time periods as X. Then, define event Cₜ_{₁}_{·t}_{₂} as the conversion that happened between time t₁ and time t₂, which means that the conversion did not happen before time t₁. ACₜ_{₁}_{·t}_{₂} denotes the event that an attributed conversion happened between times t₁ and t₂, conditioned on no conversion happening before time t₁. The expectation of bid price given bid price b can be written as four parts:

Part one: win the bid and get a conversion between T_{N-1} and T_{N}:

(1)=w(b, T_{N-1})*P(C_{T}_{_{N−1}}_{, T}_{_{N}}|\vec{c₀}(T_{N-1}, \vec{c}))*[M*P(AC_{T}_{_{N−1}}_{, T}_{_{N}}|C_{T}_{_{N−1}}_{, T}_{_{N}}, \vec{c₀}(T_{N-1}, \vec{c}), \vec{α₀}(T_{N-1}, \vec{α}))−X−cost(b, T_{N-1})]

Part two: win the bid but no conversion happened between T_{N-1} and T_{N}: Let

\vec{c₀′}=h(T_{N-1}, T_{N}, \vec{c₀}(T_{N-1}, \vec{c}))

\vec{α₀′}=k(T_{N-1}, T_{N}, \vec{α₀}(T_{N-1}, \vec{α}))

Then:

$$\begin{matrix}( 2 ) = w ( b , {T}_{N - 1} ) * ( 1 - P ( {C}_{{T}_{N - 1} , {T}_{N}} \vert \vec{{c}_{0}} ( {T}_{N - 1} , \vec{c} ) ) ) * \\ {V}_{{T}_{N}} ( \vec{{c}_{0}^{′}} , \vec{{a}_{0}^{′}} , X + cost ( b , {T}_{N - 1} ) ) \\ = w ( b , {T}_{N - 1} ) * ( 1 - P ( {C}_{{T}_{N - 1} , {T}_{N}} \vert \vec{{c}_{0}} ( {T}_{N - 1} , \vec{c} ) ) ) * \\ [ {V}_{{T}_{N}} ( \vec{{c}_{0}^{′}} , \vec{{a}_{0}^{′}} , X ) - cost ( b , {T}_{N - 1} ) ]\end{matrix}$$

Part three: lose the bid but get a conversion between T_{N-1} and T_{N}:

(3)=(1−w(b, T_{N-1}))*P(C_{T}_{_{N−1}}_{, T}_{_{N}}|\vec{c})*[M* P(AC_{T}_{_{N−1}}_{, T}_{_{N}}|C_{T}_{_{N−1}}_{, T}_{_{N}}, \vec{c}, \vec{α})−X]

Part four: lose the bid and no conversion happened between T_{N-1} and T_{N}: Let

\vec{c′}=h(T_{N-1}, T_{N}, \vec{c})

\vec{α′}=k(T_{N-1}, T_{N}, \vec{α})

Then:

(4)=(1−w(b, T_{N-1}))*[1−P(C_{T}_{_{N−1}}_{, T}_{_{N}}|\vec{c})]* V_{T}_{_{N}}(\vec{c′}, \vec{α′}, X)

Next, since the attribution rate state variable \vec{α} does not influence the evolution of conversion rate, we have:

P(AC_{T}_{_{N−1}}_{, T}_{_{N}}|\vec{c}, \vec{α})=P(C_{T}_{_{N−1}}_{, T}_{_{N}}|\vec{c})*P(AC_{T}_{_{N−1}}_{, T}_{_{N}}|C_{T}_{_{N−1}}_{, T}_{_{N}}\vec{c}, \vec{α})

where

$$P ( A {C}_{{T}_{N - 1} , {T}_{N}} \vert \vec{c} , \vec{a} ) = {\int }_{{T}_{N - 1}}^{{T}_{N}} f ( {T}_{N - 1} , t , \vec{c} ) * g ( k ( {T}_{N - 1} , t , \vec{a} ) ) * d t$$

$$P ( {C}_{{T}_{N - 1} , {T}_{N}} \vert \vec{c} ) = {\int }_{{T}_{N - 1}}^{{T}_{N}} f ( {T}_{N - 1} , t , \vec{c} ) * d t$$

Then define a function:

$$\begin{matrix}{G}_{{t}_{1} , {t}_{2}} ( \vec{c} , \vec{a} ) = ( 1 - P ( {C}_{{t}_{1} , {t}_{2}} \vert \vec{c} ) ) * [ {V}_{{T}_{N}} ( h ( {t}_{1} , {t}_{2} , \vec{c} ) , k ( {t}_{1} , {t}_{2} , \vec{a} ) , X ) + X ] \\ = ( 1 - P ( {C}_{{t}_{1} , {t}_{2}} \vert \vec{c} ) ) * {R}_{{T}_{N}} ( h ( {t}_{1} , {t}_{2} , \vec{c} ) , k ( {t}_{1} , {t}_{2} , \vec{a} ) )\end{matrix}$$

Thus, the expected profit for period T_{N-1} is:

$${E}_{{T}_{N - 1}} [ Profit \vert \vec{c} , \vec{a} , X ] ( b ) = M * P ( A {C}_{{T}_{N - 1} , {T}_{N}} \vert \vec{c} , \vec{a} ) + {G}_{{T}_{N - 1} , {T}_{N}} ( \vec{c} , \vec{a} ) + w ( b , {T}_{N - 1} ) \{ M * [ P ( A {C}_{{T}_{N - 1} , {T}_{N}} \vert \vec{{c}_{0}} ( {T}_{N - 1} , \vec{c} ) , \vec{{a}_{0}} ( {T}_{N - 1} , \vec{a} ) ) - P ( A {C}_{{T}_{N - 1} , {T}_{N}} \vert \vec{c} , \vec{a} ) ] + {G}_{{T}_{N - 1} , {T}_{N}} ( \vec{{c}_{0}} ( {T}_{N - 1} , \vec{c} ) , \vec{{a}_{0}} ( {T}_{N - 1} , \vec{a} ) ) - {G}_{{T}_{N - 1} , {T}_{N}} ( \vec{c} , \vec{a} ) - cost ( b , {T}_{N - 1} ) \} - X$$

Again, since it's a second price auction, the optimal bidding price is:

$${b}^{*} = M * ( P ( {AC}_{{T}_{N - 1} , {T}_{N}} \vert \vec{{c}_{0}} ( {T}_{N - 1} , \vec{c} ) , \vec{{a}_{0}} ( {T}_{N - 1} , \vec{a} ) ) - P ( {AC}_{{T}_{N - 1} , {T}_{N}} \vert \vec{c} , \vec{a} ) ) + {G}_{{T}_{N - 1} , {T}_{N}} ( \vec{{c}_{0}} ( {T}_{N - 1} , \vec{c} ) , \vec{{a}_{0}} ( {T}_{N - 1} , \vec{a} ) ) - {G}_{{T}_{N - 1} , {T}_{N}} ( \vec{c} , \vec{a} )$$

$${V}_{{T}_{N - 1}} ( \vec{c} , \vec{a} , X ) = p ( {b}^{*} , {T}_{N - 1} ) + M * P ( {AC}_{{T}_{N - 1} , {T}_{N}} \vert \vec{c} , \vec{a} ) + {G}_{{T}_{N - 1} , {T}_{N}} ( \vec{c} , \vec{a} ) - X$$

$${R}_{{T}_{N - 1}} ( \vec{c} , \vec{a} ) = p ( {b}^{*} , {T}_{N - 1} ) + M * P ( {AC}_{{T}_{N - 1} , {T}_{N}} \vert \vec{c} , \vec{a} ) + {G}_{{T}_{N - 1} , {T}_{N}} ( \vec{c} , \vec{a} )$$

Based on the calculation above, we see that the cost spent X never gets involved in the optimization scheme for any period. Because we start with X=0, by induction, X can be made to disappear in all the following periods. Hence, X may be eliminated from the dynamic programming, leaving only the revenue function.

Summary:

Final period T_{N}:

$${b}_{{T}_{N}}^{*} ( \vec{c} , \vec{a} ) = M * ( P ( {AC}_{{T}_{N}} \vert \vec{{c}_{0}} ( {T}_{N} , \vec{c} ) , \vec{{a}_{0}} ( {T}_{N} , \vec{a} ) ) - P ( {AC}_{{T}_{N}} \vert \vec{c} , \vec{a} ) )$$

$${R}_{{T}_{N}} ( \vec{c} , \vec{a} ) = p ( {b}^{*} , {T}_{N} ) + M * P ( {AC}_{{T}_{N}} \vert \vec{c} , \vec{a} , )$$

Period T_{N-1}:

$${b}_{{T}_{N - 1}}^{*} ( \vec{c} , \vec{a} ) = M * ( P ( {AC}_{{T}_{N - 1} , {T}_{N}} \vert \vec{{c}_{0}} ( {T}_{N - 1} , \vec{c} ) , \vec{{a}_{0}} ( {T}_{N - 1} , \vec{a} ) ) - P ( {AC}_{{T}_{N - 1} , {T}_{N}} \vert \vec{c} , \vec{a} ) ) + {G}_{{T}_{N - 1} , {T}_{N}} ( \vec{{c}_{0}} ( {T}_{N - 1} , \vec{c} ) , \vec{{a}_{0}} ( {T}_{N - 1} , \vec{a} ) ) - {G}_{{T}_{N - 1} , {T}_{N}} ( \vec{c} , \vec{a} )$$

$${R}_{{T}_{N - 1}} ( \vec{c} , \vec{a} ) = p ( {b}^{*} , {T}_{N - 1} ) + M * P ( {AC}_{{T}_{N - 1} , {T}_{N}} \vert \vec{c} , \vec{a} ) + {G}_{{T}_{N - 1} , {T}_{N}} ( \vec{c} , \vec{a} )$$

Expected Attribution Conversion Probability:

Under this optimal bidding strategy, embodiments may calculate an expected attribution conversion probability.

In the following, Pₜ(\vec{c}, \vec{α}) denotes the probability that an attributed conversion happened after time t given that the conversion did not occur before time t and the state variables start at \vec{c} and \vec{α} before the bidding. The expressions P(·|\vec{c}, \vec{α}) represent probabilities conditioned on the states after the bidding.

For final period T_{N}:

$${P}_{{T}_{N}} ( \vec{c} , \vec{a} ) = w ( {b}_{{T}_{N}}^{*} ( \vec{c} , \vec{a} ) , {T}_{N} ) * P ( {AC}_{{T}_{N}} \vert \vec{{c}_{0}} ( {T}_{N} , \vec{c} ) , \vec{{a}_{0}} ( {T}_{N} , \vec{a} ) ) + ( 1 - W ( {b}_{{T}_{N}}^{*} ( \vec{c} , \vec{a} ) , {T}_{N} ) ) * P ( {AC}_{{T}_{N}} \vert \vec{c} , \vec{a} )$$

By induction, for period T_{N-1}:

$${P}_{{T}_{N - 1}} ( \vec{c} , \vec{a} ) = w ( {b}_{{T}_{N - 1}}^{*} ( \vec{c} , \vec{a} ) , {T}_{N - 1} ) * \{ P ( A {C}_{{T}_{N - 1} , {T}_{N}} \vert \vec{{c}_{0}} ( {T}_{N - 1} , \vec{c} ) , \vec{{a}_{0}} ( {T}_{N - 1} , \vec{a} ) ) + [ 1 - P ( {C}_{{T}_{N - 1} , {T}_{N}} \vert \vec{{c}_{0}} ( {T}_{N - 1} , \vec{c} ) ) ] * {P}_{{T}_{N}} ( \vec{{c}_{0}^{′}} , \vec{{a}_{0}^{′}} ) \} + ( 1 - w ( {b}_{{T}_{N - 1}}^{*} ( \vec{c} , \vec{a} ) , {T}_{N - 1} ) ) * \{ P ( A {C}_{{T}_{N - 1} , {T}_{N}} \vert \vec{c} , \vec{a} ) + [ 1 - P ( {C}_{{T}_{N - 1} , {T}_{N}} \vert \vec{c} ) ] * {P}_{{T}_{N}} ( \vec{{c}^{′}} , \vec{{a}^{′}} ) \}$$

Thus, we are able to calculate P_{T}_{₁}(\vec{c₀}, \vec{α₀})with the formula given above.

Expected Cost

We are also able to calculate the expected cost under this bidding scheme.

Let Costₜ(\vec{c}, \vec{α}) denote the expected cost conditioned on the event that no conversion happened before time t, where before a bidding at time t the state variables are \vec{c} and \vec{α}.

For final period T_{N}:

Cost_{T}_{_{N}}(\vec{c}, \vec{α})=w(b_{T}_{_{N}}*(\vec{c}, \vec{α}), T_{N})*cost(b_{T}_{_{N}}*(\vec{c}, \vec{α}), T_{N})

By induction, for period T_{N-1}:

$${Cost}_{{T}_{N - 1}} ( \vec{c} , \vec{a} ) = w ( {b}_{{T}_{N - 1}}^{*} ( \vec{c} , \vec{a} ) , {T}_{N - 1} ) * \{ cost ( {b}_{{T}_{N - 1}}^{*} ( \vec{c} , \vec{a} ) , {T}_{N - 1} ) + [ 1 - P ( {C}_{{T}_{N - 1} , {T}_{N}} \vert \vec{{c}_{0}} ( {T}_{N - 1} , \vec{c} ) ) ] * {Cost}_{{T}_{N}} ( \vec{{c}_{0}^{′}} , \vec{{a}_{0}^{′}} ) \} + ( 1 - w ( {b}_{{T}_{N - 1}}^{*} ( \vec{c} , \vec{a} ) , {T}_{N} ) ) * [ 1 - P ( {C}_{{T}_{N - 1} , {T}_{N}} \vert \vec{c} ) ] * {Cost}_{{T}_{N}} ( \vec{{c}^{′}} , \vec{{a}^{′}} )$$

Observations:

Bidding is usually done based on how much an impression can boost the current and following periods' revenue. And the total revenue we earn by bidding contains three parts

1. Expected bidding premium

2. Profit of attributed conversion within current period given no impression happened

3. Revenue for the following periods given conversion does not happen within the current period and no impression is delivered.

We can always earn part 2 and 3 without any operation. Therefore, the money we earn are effectively all from the premium of bidding. And a higher probability of attributed conversion usually gives us more money to bid on, hence endue us with more premium.

One equality that can be used to check the correctness of the calculation is:

Rₜ(\vec{c}, \vec{α})=M*Pₜ(\vec{c}, \vec{α})−Costₜ(\vec{c}, \vec{α})

It means we can also interpret our profit as the intuitive expected revenue minus expected cost.

In one example,

w(b)=exp(0.5*log(bid)+1.5)/(exp(0.5*log(bid)+1.5)+1)

The cost function is calculated based on the assumption that the winning threshold is independent of our evaluation.

M=20

The conversion probability=0.0001

$${T}_{C} \sim 0.25 * exp ( \frac{1}{3000} ) + 0.75 * exp ( \frac{1}{150000} )$$

A(t)=0.75−0.066*log(t) and k(α)=α

Tᵢ=seq(0, 400000, 400000/i), where i is the number of impression opportunity.

Given these conditions,

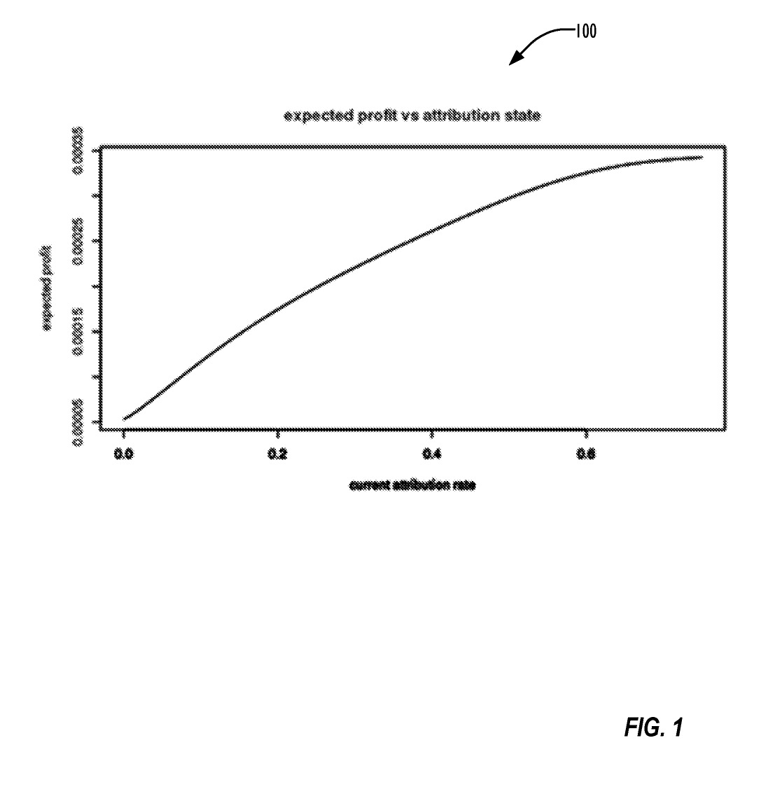

FIG. 1 is a graph 100 illustrating expected profit versus attribution state along attribution state (i=100).

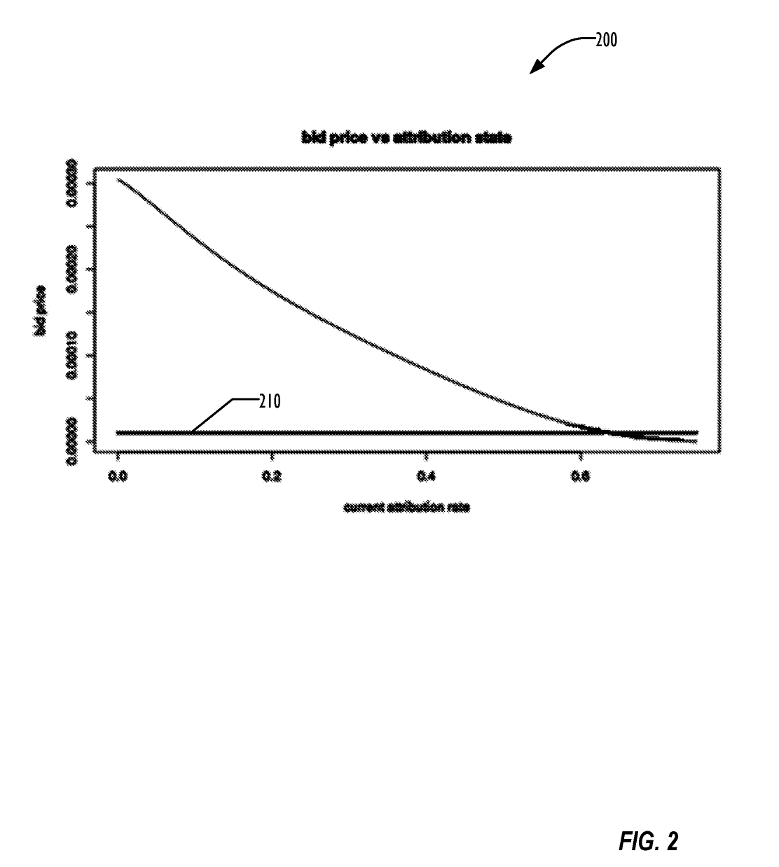

FIG. 2 is a graph 200 illustrating bid price versus attribution state along attribution state (i=100). The line 210 of FIG. 2 is the minimal amount we could bid (1 cents/1000).

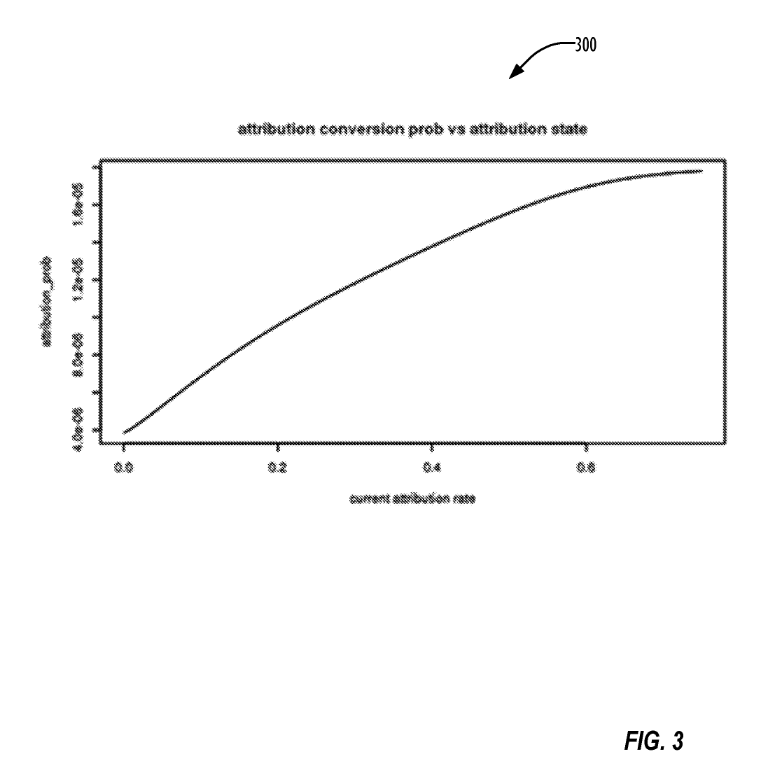

FIG. 3 is a graph 300 illustrating attribute conversion probability versus attribution state along attribution state (i=100).

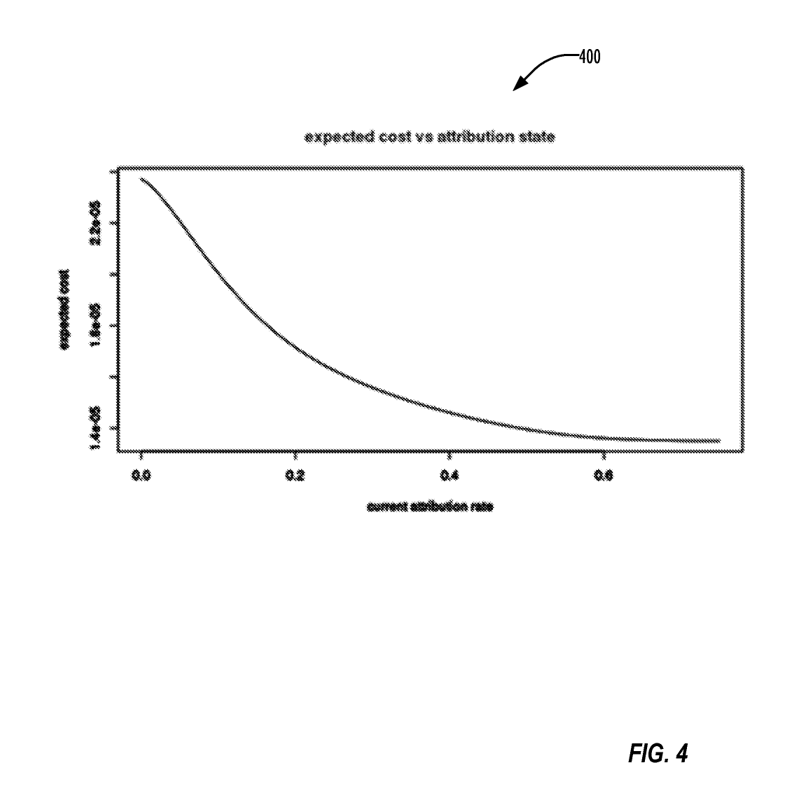

FIG. 4 is a graph 400 illustrating expected cost versus attribution state along attribution state (i=100).

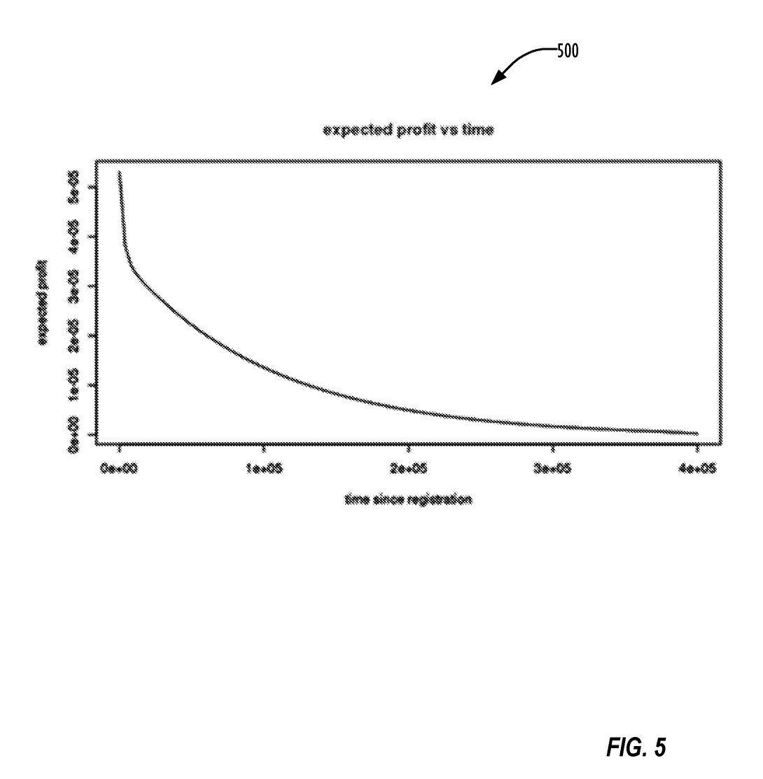

FIG. 5 is a graph 500 illustrating expected profit versus time along time since registration (i=100).

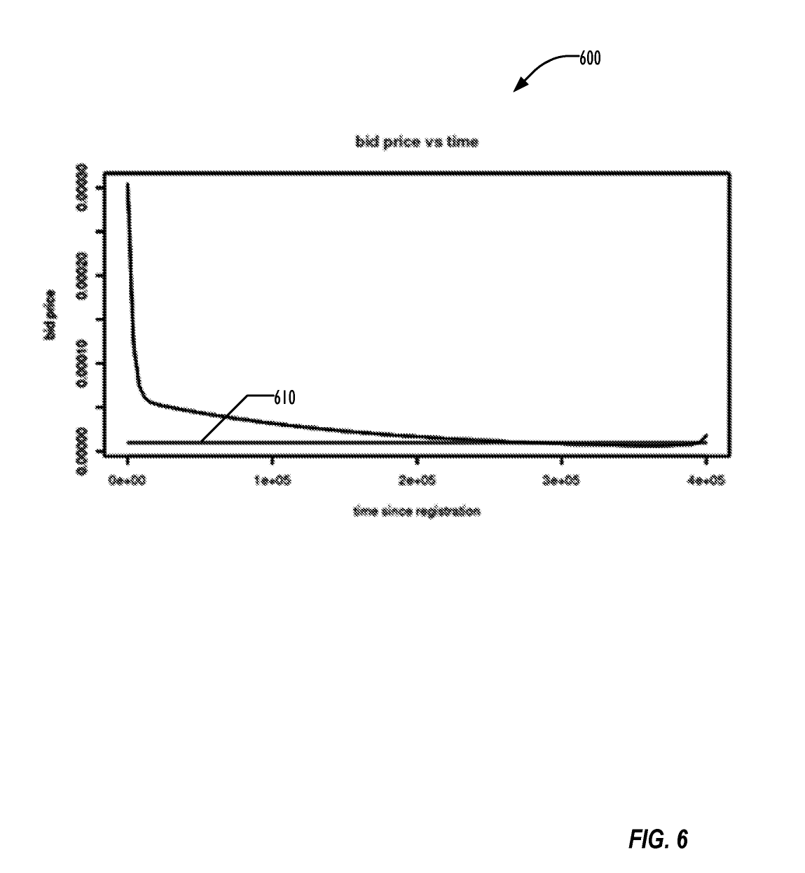

FIG. 6 is a graph 600 illustrating bid price versus time along time since registration (i=100). The line 610 of FIG. 6 is the minimal amount we could bid (1 cents/1000).

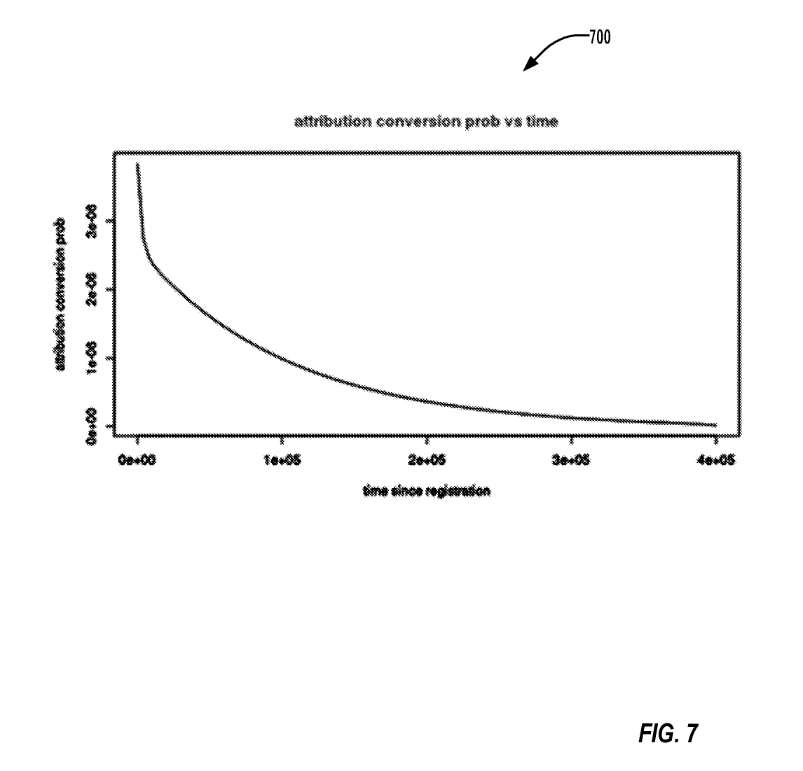

FIG. 7 is a graph 700 illustrating attribution conversion probability versus time along the time since registration (i=100).

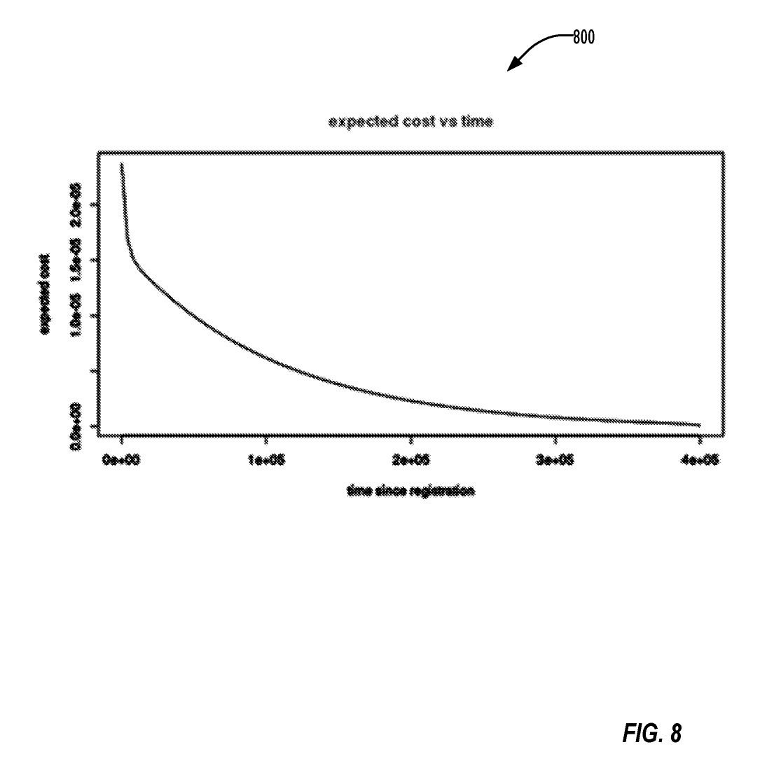

FIG. 8 is a graph 800 illustrating expected cost versus time along time since registration (i=100).

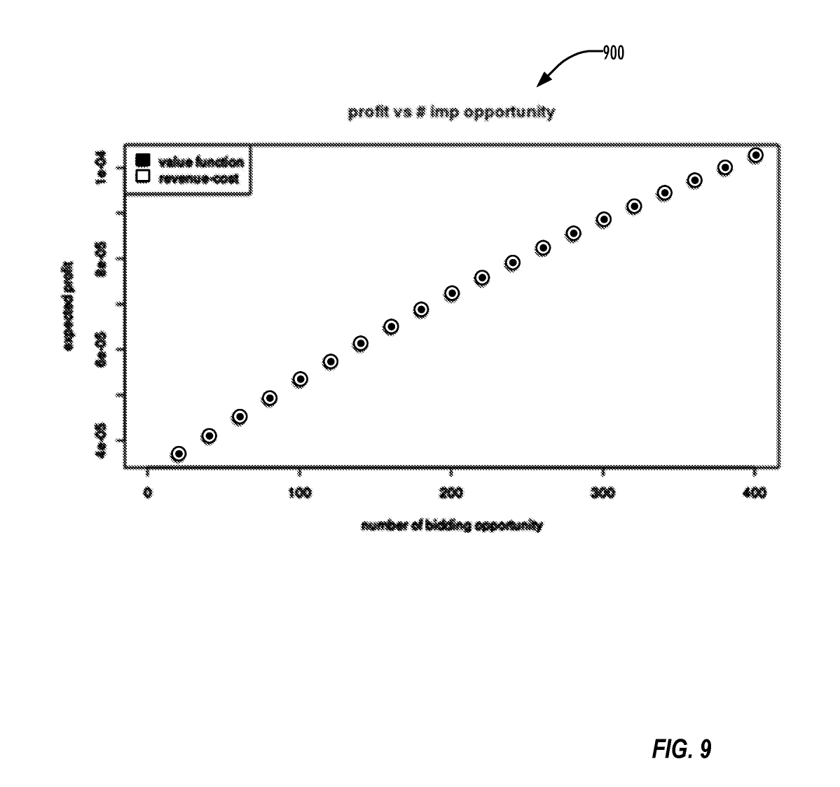

FIG. 9 is a graph 900 illustrating profit versus number of impression opportunity along number of bidding opportunities along number of bidding opportunities (i=seq(20,400,20)).

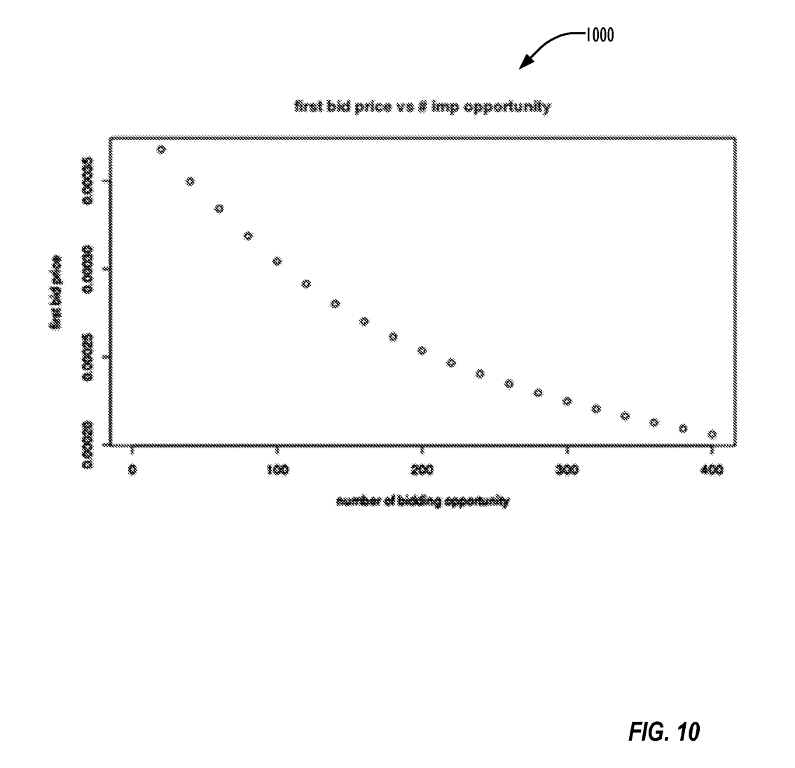

FIG. 10 is a graph 1000 illustrating first bid price versus number of impressions opportunity along number of bidding opportunities (i=seq (20,400,20)).

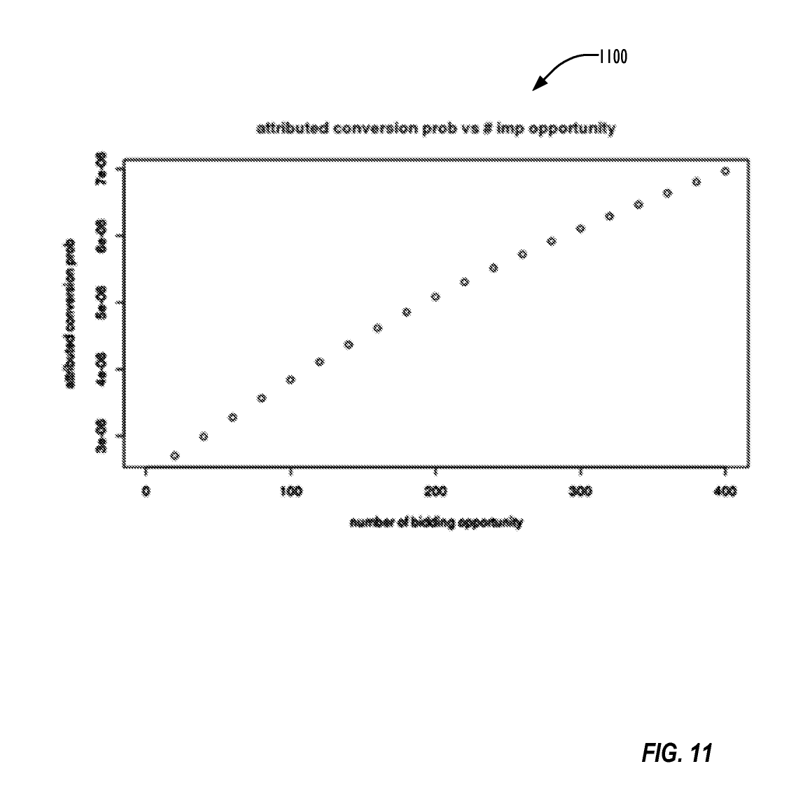

FIG. 11 is a graph 1100 illustrating attributed conversion probability versus number of impressions opportunity along number of bidding opportunities (i=seq (20,400,20)).

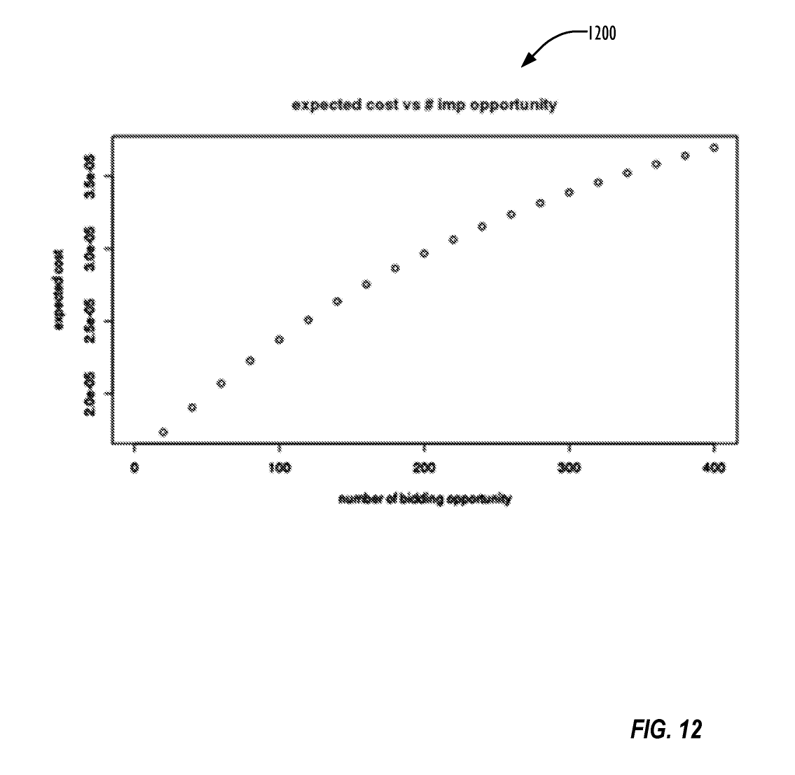

FIG. 12 is a graph 1200 illustrating expected cost versus number of impressions opportunity along number of bidding opportunities (i=seq (20,400,20)).

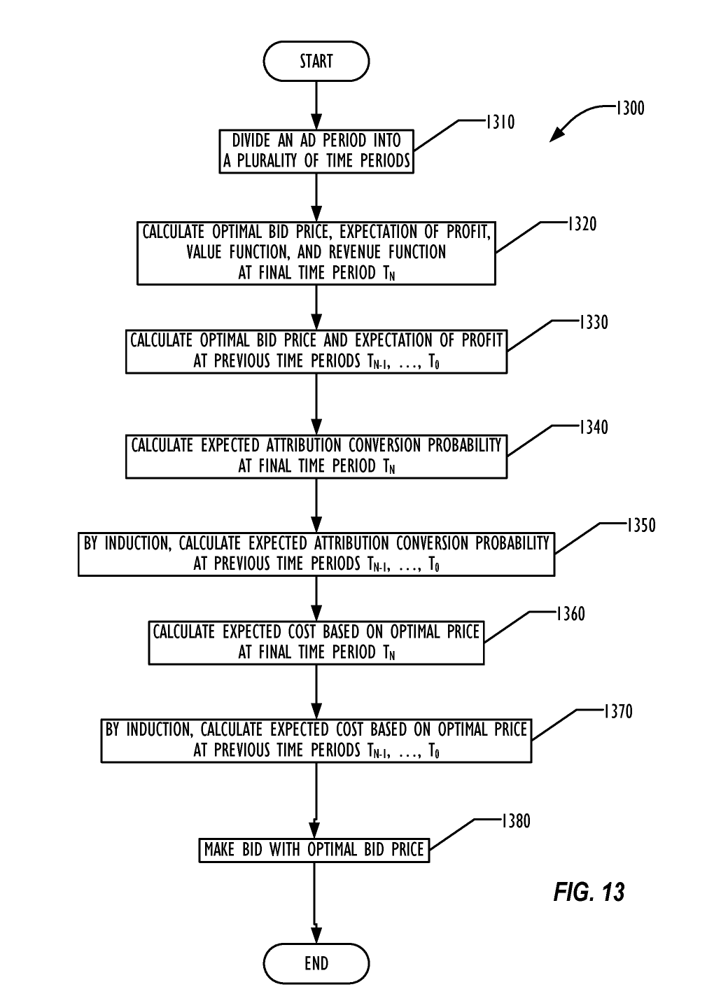

FIG. 13 is a flowchart 1300 illustrating a technique for calculating optimal bid price, expectation of profit, expected attribution conversion probabilities, and expected costs according to one embodiment.

In block 1310, the period for the advertisement is divided into a plurality of time periods, where the final time period is designated time period T_{N}.

In block 1320, an optimal bid price b* and an expectation of profit E_{T}_{_{N}}[Profit|\vec{c}, \vec{α}, X](b) are calculated as described above for final time period T_{N}. In block 1330, optimal bid prices b* and expectations of profit E_{T}_{ᵢ}[Profit|\vec{c}, \vec{α}, X](b) are calculated by induction for T_{N-1}, . . . , T₁ as described above.

Similarly in blocks 1340-1350, the expected attribution conversion probability may be calculated at times T_{N}, . . . , T₁ as described above.

Similarly in block 1360-1370, the expected cost based on the optimal price may be calculated at times T_{N}, . . . , T₁ as described above.

Some embodiments may only calculate the optimal bid price. Other embodiments may calculate any one or more of the other values calculated above.

Finally, in block 1380, a bid may be made using the optimal bid price calculated previously.

Importantly, the calculations described above cannot be performed usefully by a human being, because of the quantity of calculations that must be performed within the time allowed for making the bid, which is typically on the order of milliseconds. Thus a computational solution to the technical problem of determining the optimal bid price is necessary.

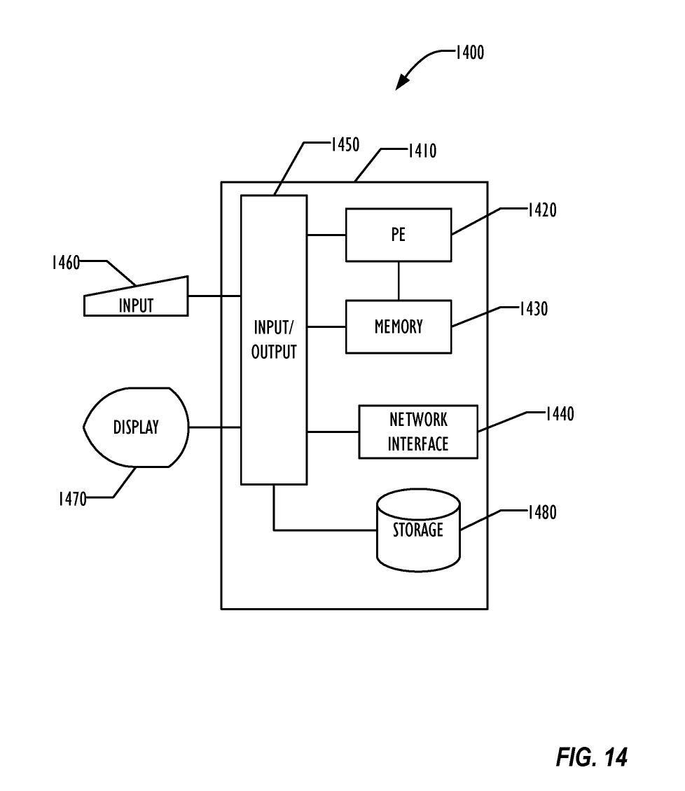

FIG. 14 is a block diagram illustrating a computer system 1400 for use in calculating the functions described above. A system unit 1410 may incorporate one or more processing elements 1420, memory 1430, input/output interfaces 1450, a network interface 1440, and a storage device 1480. In some embodiments, and input device 1460 allows for user interaction with the computer system 1400, such as with a keyboard, mouse, etc. Similarly, embodiments may provide a display 1470 for displaying information to a user of the computer system 1400. The storage device 1480 may store data as well as program instructions for programming the computer system 1400 to perform the calculations described above. Although illustrated as contained in the system unit 1400, any of the components 1430-1440 may be external devices, including remote devices as desired.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method for determining an optimal bid price for an advertisement in a second price auction, comprising:
dividing an advertisement period into a plurality of time periods;
calculating an optimal bid price for a final time period of the plurality of time periods;
calculating an optimal bid price for each predecessor time period of the plurality of time periods; and
placing a bid for the advertisement using the optimal bid price calculated for a first time period of the plurality of time periods.

2. The method of claim 1, further comprising:
calculating an expectation of profit for the final time period; and
calculating an expectation of profit for each predecessor time period of the plurality of time periods.

3. The method of claim 1, further comprising:
calculating an expected attribution conversion probability for the final time period; and
calculating an expected attribution conversion probability for each predecessor time period of the plurality of time periods.

4. The method of claim 1, further comprising:
calculating an expected cost for the final time period based on the optimal bid price for the final time period; and
calculating an expected cost for each predecessor time period of the plurality of time periods based on the optimal bid price for the corresponding time period.

5. The method of claim 1, wherein calculating the optimal bid price at any time period of the plurality of time periods is independent of prior spending.

6. The method of claim 1, wherein the optimal bid price depends upon a function that gives a winning rate for an arbitrary bidding price at a given time.

7. The method of claim 1, wherein the optimal bid price depends upon a cost function that gives a conditional expectation of bidding cost given winning.

8. The method of claim 1, wherein the optimal bid price depends upon a premium function that gives an expectation of bidding profit.

9. The method of claim 1, wherein the premium function depends upon the win rate function and the cost function.

10. The method of claim 1, wherein the optimal bid price depends upon a conditional conversion probability function with a Markovian evolving state variable.

11. A non-transitory computer readable medium on which are stored instructions for determining an optimal bid price for an online advertisement in a second price auction, comprising instructions that when executed, program a computer system to:
divide an advertisement period into a plurality of time periods;
calculate an optimal bid price for a final time period of the plurality of time periods;
calculate an optimal bid price for each predecessor time period of the plurality of time periods; and
place a bid for the advertisement using the optimal bid price calculated for a first time period of the plurality of time periods.

12. The computer readable medium of claim 11, wherein the instructions further comprise instructions that when executed cause the computer system to:
calculate an expectation of profit for the final time period; and
calculate an expectation of profit for each predecessor time period of the plurality of time periods.

13. The computer readable medium of claim 11, wherein the instructions further comprise instructions that when executed cause the computer system to:
calculate an expected attribution conversion probability for the final time period; and
calculate an expected attribution conversion probability for each predecessor time period of the plurality of time periods.

14. The computer readable medium of claim 11, wherein the instructions further comprise instructions that when executed cause the computer system to:
calculate an expected cost for the final time period based on the optimal bid price for the final time period; and
calculate an expected cost for each predecessor time period of the plurality of time periods based on the optimal bid price for the corresponding time period.

15. The computer readable medium of claim 11, wherein the optimal bid price at any time period of the plurality of time periods is independent of prior spending.

16. The computer readable medium of claim 11, wherein the optimal bid price depends upon a function that gives a winning rate for an arbitrary bidding price at a given time.

17. The computer readable medium of claim 11, wherein the optimal bid price depends upon a cost function that gives a conditional expectation of bidding cost given winning.

18. The computer readable medium of claim 11, wherein the optimal bid price depends upon a premium function that gives an expectation of bidding profit.

19. The computer readable medium of claim 11, wherein the premium function depends upon the win rate function and the cost function.

20. The computer readable medium of claim 11, wherein the optimal bid price depends upon a conditional conversion probability function with a Markovian evolving state variable.
